(19) United States
(12) Patent Application Publication
(10) Pub. No.: US 2013/0214110 A1
(43) Pub. Date: Aug. 22, 2013

(54) ERGONOMIC MOUSEPAD

(71) Applicant: Aviiq IP Inc, (US)

(72) Inventors: Tony Crisp, Santa Ana, CA (US); Matthew McLain Brechbuhler, Glendale, CA (US)

(73) Assignee: Aviiq IP Inc, Hong Kong (CN)

(21) Appl. No.: 13/766,486

(22) Filed: Feb. 13, 2013

Related U.S. Application Data
(60) Provisional application No. 61/598,787, filed on Feb. 14, 2012.

(51) Int. Cl. G06F 3/039

(52) U.S. Cl. CPC G06F 3/0395
USPC 248/346.01

(57) ABSTRACT

A mousepad having a particularly ergonomic form factor is provided for operating a mouse or other peripheral input device thereon. The mousepad is particularly well suited for protecting the wrist and forearm of users from abrasion and discomfort arising from inadvertent contact with a desk, table or other support structure that is supporting the mousepad. The mousepad is configured to mask a corner of such support structures with a portion of the mousepad that has a gradual curvature. The mousepad may include a base portion having an upper surface upon which the mouse device can operate and a clamp portion to selectively attach the mousepad to the desk, table or other support structure. Methods of attaching the mousepad to a desk, table or other support structure are also provided.

### CROSS-REFERENCE TO RELATED APPLICATIONS

This application claims the benefit under 35 U.S.C. §119(e) of U.S. Provisional Patent Application No. 61/958,787, filed Feb. 14, 2012, the entire disclosure of which is herein incorporated by reference for all purposes.

### BACKGROUND

1. Technical Field

The present disclosure is related to mousepads, and more particularly, to mousepads having ergonomic features.

2. Description of the Related Art

It is common for computer users, including computer gamers, to have a mousepad on which a computer mouse or similar device can roll or slide to control elements on a visual display. Most often, the mousepad rests on the surface of a table, desk or other support structure. Repeated use of the computer mouse or similar device for prolonged periods can lead to fatigue and stiffness of a user's arm or wrist. Consequently, users often rest their wrists or forearms on the table, desk or other support structure that is supporting the mousepad. To enhance user comfort, some mousepads are known which include a raised wrist support portion at a forward end of the mousepad. The typical mousepad, however, often features simply a flat, rectangular sheet-like pad.

### BRIEF SUMMARY

The mousepad structures and methods of making and using the same described herein provide for operating a mouse or other peripheral input device on a mousepad having a particularly ergonomic form factor. The mousepads are particularly well suited for protecting the wrist and forearm of users from abrasion and discomfort arising from inadvertent contact with a desk, table or other support structure that is supporting the mousepad.

According to one embodiment, a mousepad may be summarized as including a base portion having an upper surface upon which the mouse device can operate and a clamp portion to selectively attach the mousepad to a support structure. The clamp portion may be movable between an unexpanded configuration and an expanded configuration, wherein opposing sections of the clamp portion move away from each other when the clamp portion moves from the unexpanded configuration toward the expanded configuration to receive the support structure. The mousepad may further include at least one stop on an underside of the mousepad that is positioned to abut the support structure when the mousepad is attached thereto. The stop may be integrally formed in a layer of the mousepad and may be positioned within an elongated cavity defined by the clamp portion when the clamp portion is in the unexpanded configuration.

A profile of the clamp portion may include a gradual curvature from an area near an interface of the base portion and the clamp portion toward a nose of the mousepad to mask any sharp edge at the end of the support structure when the mousepad is attached to the support structure. The profile of the clamp portion may include a general c-shape, wherein a height of the c-shape varies as the clamp portion moves between the unexpanded configuration and the expanded configuration. The mousepad may further include a generally c-shaped spring element integrally formed in a layer of the mousepad to increase resiliency of the clamp portion. A relief gap may also be provided in the clamp portion near the nose of the mousepad to enable flexing to a relatively greater degree without damage of the clamp portion. The clamp portion may further include a pair of legs and a raised lip positioned between the pair of legs thereof to enable a user to displace the pair of legs of the clamp portion away from the unexpanded configuration.

The base portion of the mousepad may be a single layer or a multi-layered structure including at least a lower layer and an upper layer. The lower layer and the upper layer may be, for example, neoprene materials having different porosities. The multi-layered structure may further include a fabric skin, such as, for example, a Lycra™ fiber skin or woven polyester fiber skin, a plastic skin, or a skin of various other materials to increased wear resistance of the mousepad or enhance operational performance. The upper layer of the base portion may seamlessly extend at least to a nose of the mousepad such that the upper layer defines at least a part of the clamp portion. The upper layer of the base structure may seamlessly extend past the nose such that the second layer has a general j-shape when the mousepad is attached to the support structure. In this manner, the base portion and clamp portion are at least partially integrally formed together.

According to another embodiment, a mousepad may be summarized as including a sheet structure having an upper surface upon which a mouse device can operate and a resilient, generally c-shaped clamp coupled to the sheet structure, the clamp expandable from an initial configuration to an expanded configuration for selectively attaching the mousepad to a generally planar support structure of various thicknesses. The mousepad is configured to mask a corner of the support structure with a portion of the mousepad having a gradual curvature when the mousepad is attached to the support structure.

According to another embodiment, a mousepad may be summarized as including a base portion having an upper surface upon which the mouse device can operate and a nose portion formed together with the base portion. The nose portion may be configured to be cantilevered from a support structure when the mousepad is positioned for use and the nose portion may include a profile with a gradual curvature which traces a profile that changes, according to some embodiments, in direction at least about thirty-five degrees from a direction defined by the base portion of the mousepad when positioned for use, and in other embodiments, at least about fifty-five degrees. In still further embodiments, the nose portion may include a profile with a gradual curvature which traces a profile that changes in direction at least about seventy-five degrees from a direction defined by the base portion of the mousepad when positioned for use. The mousepad may further include a clamp integrally formed with the nose portion, the clamp configured to selectively engage the support surface when the mousepad is positioned for use. The mousepad may further include a stop integrally formed with the nose portion, the stop positioned to abut an edge of the support structure when the mousepad is positioned for use. The nose portion of the mousepad may define a rounded tip that is positioned at least one-half inch from the edge of the support structure when the mousepad is positioned for use and the stop abuts the edge.

According to one embodiment, a method for attaching a mousepad may be summarized as including moving an end of a clamp portion of the mousepad away from a lower surface of the mousepad and positioning the mousepad such that the support structure is received by the clamp portion with a base portion of the mousepad lying on an upper support surface of the support structure. Positioning the mousepad may include moving the mousepad towards the support structure until a stop of the mousepad abuts the support structure. Positioning the mousepad may alternatively include positioning the mousepad such that a stop of the mousepad rests on the upper support surface of the support structure, the stop thereby positioning a portion of the mousepad away from the upper support surface. Moving the end of the clamp portion of the mousepad away from the lower surface of the mousepad may include moving a pair of legs of the clamp portion away from the lower surface via a raised lip positioned between the pair of legs.

### BRIEF DESCRIPTION OF THE SEVERAL VIEWS OF THE DRAWINGS

FIG. 1 is a front isometric view of a mousepad attached to a table, according to one embodiment.

FIG. 2 is an isometric view of the underside of the mousepad of FIG. 1, showing a clamp portion thereof in an unexpanded configuration.

FIG. 3 is a side elevational view of the mousepad of FIG. 1.

FIG. 4 is a top plan view of the mousepad of FIG. 1.

FIG. 5 is a partial cross-sectional view of the mousepad of FIG. 1 taken along line 5-5 of FIG. 4.

FIG. 6 is a side elevational view of the mousepad of FIG. 1, shown attached to a table in an expanded configuration.

FIG. 7 is a side elevational view of the mousepad of FIG. 1, shown attached to a table in another expanded configuration.

FIG. 8 is a partial side elevational view of a mousepad, according to another embodiment, showing a clamp portion thereof in an unexpanded configuration.

FIG. 9 is a partial side elevational view of a mousepad, according to another embodiment, showing a clamp portion thereof in an unexpanded configuration.

FIG. 10 is a side elevational view of a mousepad, according to another embodiment, shown supported on a table in a position for use.

FIG. 11 is a side elevational view of a mousepad, according to another embodiment, shown supported on a table in a position for use.

FIG. 12 is a side elevational view of a mousepad, according to another embodiment, shown supported on a table in a position for use.

FIG. 13 is a side elevational view of a mousepad, according to another embodiment, shown supported on a table in a position for use.

FIG. 14 is a perspective view of a portion of a mousepad, according to another embodiment, showing a clamp portion thereof in an unexpanded configuration.

FIG. 15 is a perspective view of a portion of a mousepad, according to yet another embodiment, in which a base portion of the mousepad is formed of a single unitary layer.

FIG. 16 is a perspective view of a mousepad, according to still yet another embodiment, in which the mousepad has a unitary body formed entirely of a flexible, resilient material.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and manufacturing techniques associated with mousepads may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

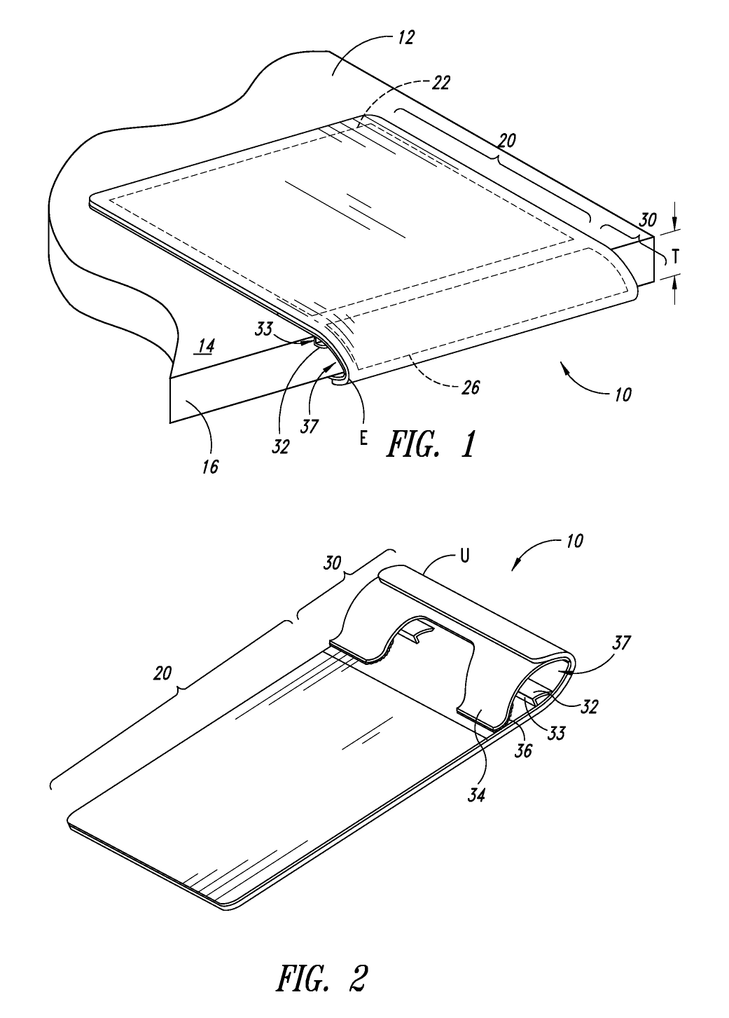

FIG. 1 shows a mousepad 10 for operating a mouse or other peripheral input device thereon. In addition to the other mousepads described herein, the mousepad 10 is particularly well suited for protecting the wrist and forearm of users from abrasion and discomfort arising from inadvertent contact with a desk, table or other support structure 12 that is supporting the mousepad 10 on an upper surface 14 thereof. The mousepad 10 includes a base portion 20 having an upper working area 22 upon which the mouse device can operate and a clamp portion 30 for selectively attaching the mousepad 10 to the desk, table or other support structure 12. The mousepad 10 is configured to mask a corner of the front edge 16 of the support structure 12 with a region 26 of the mousepad 10 that has a gradual curvature.

The mousepad 10 can be attached to the support structure 12 by opening the clamp portion 30 and sliding the mousepad 10 over the front edge 16 until a stop 32 of the mousepad 10 abuts the front edge 16, as shown in FIG. 1. In this position, the clamp portion 30 of the mousepad 10 is in an expanded configuration E in which opposing sections of the clamp portion 30 are offset from each other a sufficient distance to receive the support structure 12 therebetween. The support structure 12 may be substantially planar and have a thickness T of about one-half of an inch or more or less. For example, the support structure 12 may be a glass tabletop having a thickness of about one-quarter of an inch or a composite desktop having a thickness of about three-quarters of an inch. The clamp portion 30 of the mousepad is resilient and can flex to accommodate such support structures 12 of varying thicknesses.

FIG. 2 shows the underside of the mousepad 10. As shown in the illustrated embodiment, the clamp portion 30 includes legs 34 that are configured to flex away from a neutral or unexpanded configuration U toward an expanded configuration E (FIG. 1). In other embodiments, the clamp portion 30 may not include legs 34 but may rather extend unbroken in an extruded c-shape structure. In the illustrated embodiment of FIG. 2, the legs 34 further include feet 36 to aid in gripping the underside of the support structures 12 when attached thereto. For instance, the feet 36 may be saw-tooth structures made of natural or synthetic rubber or other materials for increasing frictional resistance between the clamp portion 30 and the support structure 12 received therein. In this manner, the mousepad 10 is particularly adapted to remain in place during operation of a mouse or other device thereon. The biasing of the legs 34 and feet 36 against the support structure 12 resist inadvertent sliding of the mousepad 10 with respect to the upper surface 14 of the support structure 12.

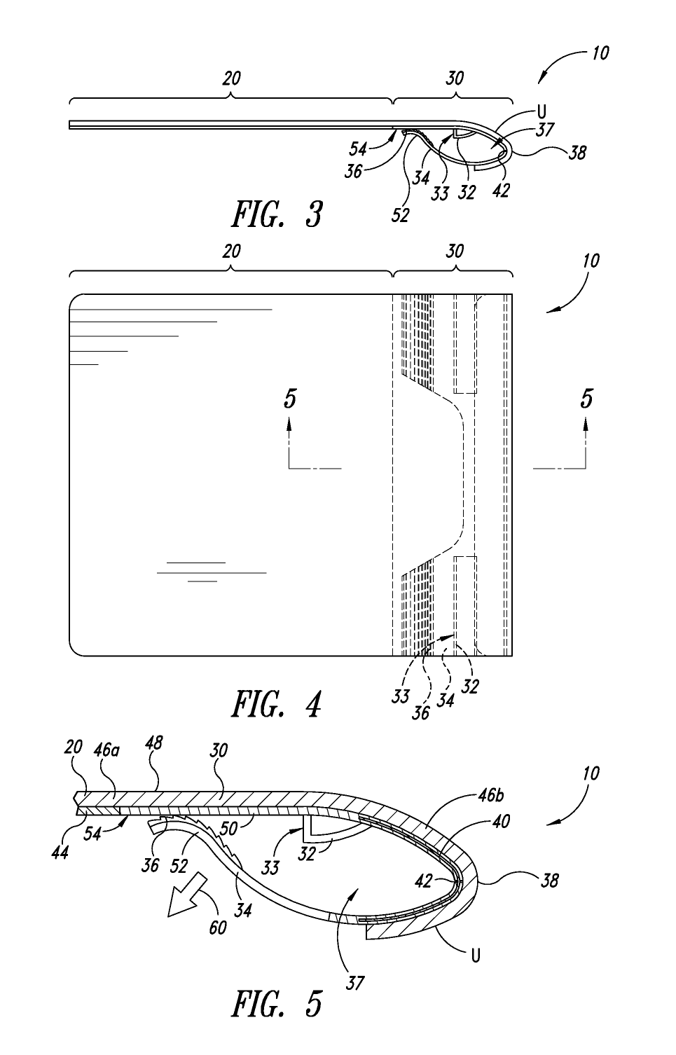

As can be appreciated from FIGS. 2 through 4, the clamp portion 30 of the mousepad 10 defines an elongated cavity 37. As described above, the mousepad 10 may include stops 32 for abutting the front edge 16 of the support structure 12 to which the mousepad 10 is attached. The stops 32 may be positioned within the elongated cavity 37 defined by the clamp portion 30. In addition, the stops 32 may be formed integrally with one or more layers of the mousepad 10. In some embodiments, a single stop 32 may be provided in a central region of the clamp portion 30 and may extend less than or more than a majority of the width of the mousepad 10. In still other embodiments, the mousepad 10 may be provided without stops 32. When provided, the stops 32 may include a front surface 33 that is perpendicular or nearly perpendicular to an adjoining surface the mousepad 10. In other embodiments, the stops 32 may include upstanding pegs, protrusions or similar structures for abutting the front edge 16 of a support structure 12.

As best shown in FIG. 5, a profile of the clamp portion 30 includes a gradual curvature from an area near an interface of the base portion 20 and the clamp portion 30 toward a nose or tip 38 of the mousepad 10. This portion with the gradual curvature masks sharp edges of the front edge 16 of the support structure 12 when the mousepad 10 is attached to the support structure 12. The profile of the clamp portion 30 further includes a general c-shape in which a height of the c-shape varies as the clamp portion 30 moves between the unexpanded configuration U, as shown in FIG. 5, and an expanded configuration E (FIG. 1). To enhance the resiliency of the clamp portion 30, the clamp portion 30 may include a spring element 40. The spring element 40 can be c-shaped and mimic the contours of other components of the clamp portion 30. In one embodiment, the spring element 40 is spring steel and is overmolded in another material, such as, for example, ABS or other plastic materials or composites. To enhance the ability of the clamp portion 30 to flex repeatedly and to a greater degree without damage, the clamp portion 30 may include one or more relief features along the c-shaped portion, such as, for example, a relief gap 42 on the inside of the clamp portion 30 near the nose or tip 38 of the mousepad 10.

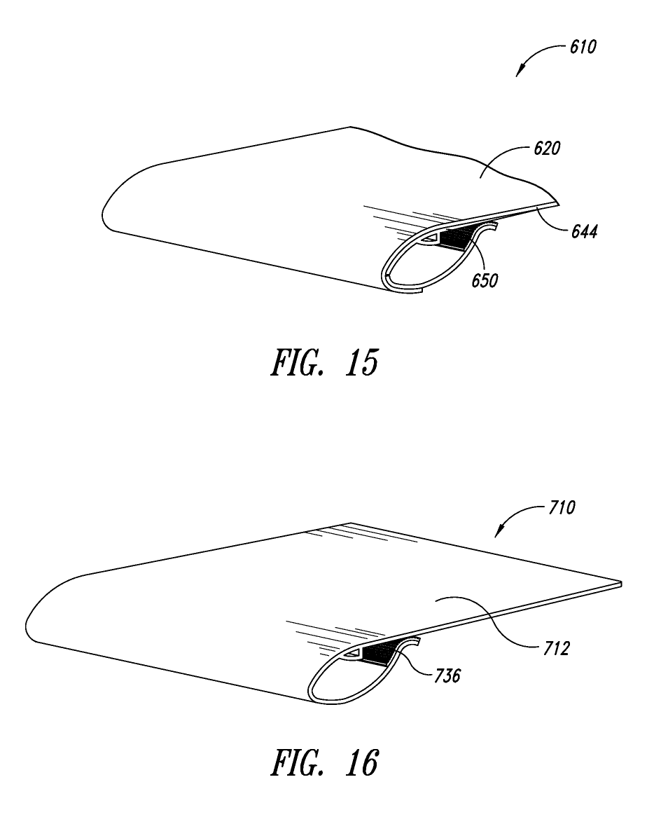

The mousepad 10 may be a single layer or a multi-layered structure having two or more layers bonded together via adhesive or other means to form a unified mousepad 10. For example, with continued reference to FIG. 5, the base portion 20 of the mousepad 10 may be a multi-layered structure including at least a lower layer 44 and an upper layer 46a. The lower layer 44 and the upper layer 46a may be a variety of different materials. It is beneficial, however, if the lower layer 44 exhibits enhanced frictional resistance to prevent slipping of the mousepad 10 on the upper surface 14 of the support structure 12 when operating a mouse or other device thereon. In addition, it is also beneficial if the upper layer 46a have the ability to provide at least moderate cushioning. In one embodiment, the lower layer 44 and the upper layer 46a are neoprene materials having different porosities. The multi-layered structure of the base portion 20 may further include a fabric skin 48, such as, for example, a Lycra™ fiber skin or woven polyester fiber skin, a plastic skin, or a skin of various other materials overlaying the upper layer 46a to provide increased wear resistance of the mousepad or enhance operational performance when sliding a mouse or other device on the mousepad 10. The fabric skin 48 may have a negligible thickness. In some embodiments, the base portion 20 may have more or fewer layers and is not limited to the structure shown in the illustrated embodiment of FIG. 5. For example, FIG. 15 shows an embodiment of a mousepad 610 having a base portion 620 formed of a single layer 644. In this embodiment, a clamp portion 650 of the mousepad 610 gradually tapers to transition smoothly with the layer 644 of the base portion 620. As another example, FIG. 16 shows an embodiment of a mousepad 710 which, apart from feet 736, has a body 712 formed entirely of a single flexible, resilient material, such as, for example, various plastic materials.

The clamp portion 30 of the mousepad 10 may also be a multi-layered structure. In the illustrated embodiment of FIG. 5, for example, the clamp portion 30 includes a lower layer 50 and an upper layer 46b which is a seamless continuation of the upper layer 46a of the base portion 20. The upper layer 46a, 46b may seamlessly extend from one end of the mousepad 10 past the nose or tip 38 of the mousepad 10 such that the upper layer 46a, 46b has a general j-shape. The lower layer 50 of the clamp portion 30 is preferably made of a semi-rigid, resilient material such that the clamp portion 30 can flex elastically between the unexpanded configuration U, as shown in FIG. 5, and an expanded configuration E, as shown, for example, in FIG. 1, without any substantial permanent deformation. In some embodiments, the lower layer 50 of the clamp portion 30 may be ABS or other plastic materials or composites.

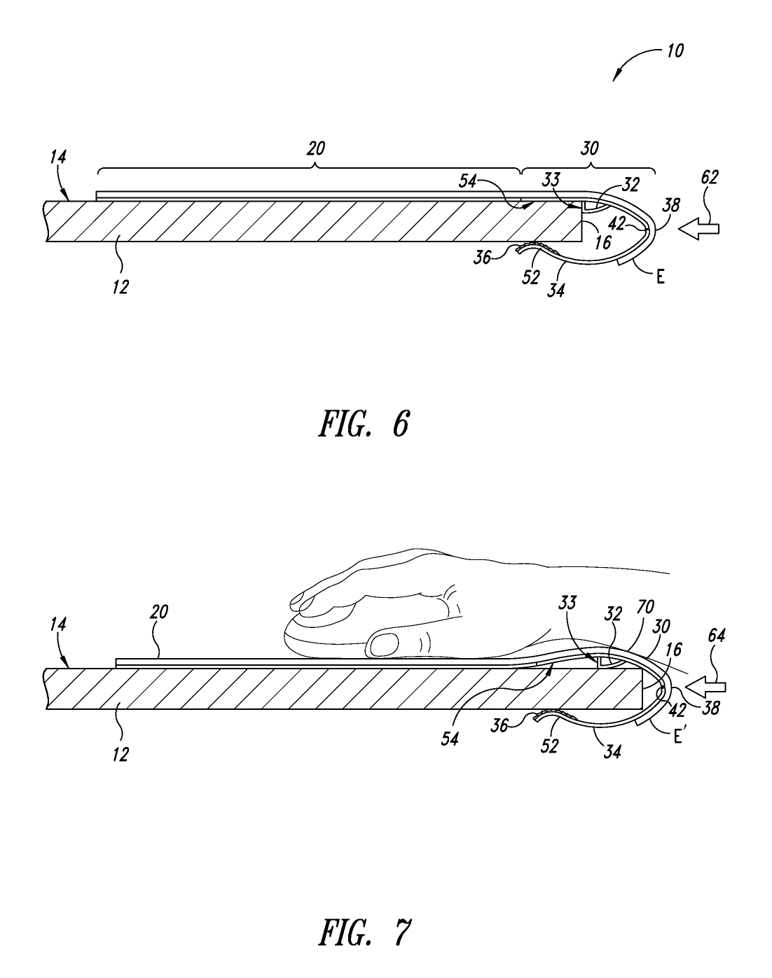

With reference now to FIGS. 5 through 7, a method for attaching a mousepad 10 to a support structure 12 may include moving an end 52 of the clamp portion 30 away from a lower surface 54 of the mousepad 10, as indicated by the arrow labeled 60 in FIG. 5. Next, a user may position the mousepad 10 on the upper surface 14 of a support structure 12 and position the clamp portion 30 over the front edge 16 thereof such that a portion of the support structure 12 is received between opposing sections of the clamp portion 30, as indicated by the arrow labeled 62 in FIG. 6. After the front edge 16 of the support structure 12 is at least partially received in the clamp portion 30, the user may release the end 52 of the clamp portion 30 such that it can spring back towards the lower surface 54 of the mousepad 10. The legs 34 and corresponding feet 36 of the clamp portion 30 press against the support structure 12 and hold the mousepad 10 in place. Positioning the mousepad 10 may include moving the mousepad 10 towards the support structure 12 until one or more stops 32 of the mousepad 10 abut the front edge 16 of the support structure 12. In this manner, the stops 32 act to space the nose or tip 38 of the mousepad 10 away from the support structure at a predetermined distance. This distance may be one-half of an inch or more or less. Irrespective of the offset distance, the clamp portion 30 of the mousepad is shaped to mask any sharp corner at the front edge 16 of the support structure 12 underlying the mousepad 10. Accordingly, a user can relax his or her arm and rest his or her forearm or wrist on the mousepad 10 without risk of abrasion or discomfort arising from contact with a sharp corner. This is particularly advantageous for computing activities, such as gaming and the like, which require frequent spontaneous movements or workplace or other settings where users are operating a mouse or similar input device for extended periods of time.

As illustrated in FIG. 7, a user also has the ability to adjust the clamp portion 30 of the mousepad 10 such that the stops 32 are repositioned to ride on the upper surface 14 of the support structure 12. In this configuration, the user can position the clamp portion 30 further onto the support structure 12, as indicated by the arrow labeled 64. For example, the user can push the clamp portion 30 forward until it abuts the support structure 12. In this configuration, the clamp portion 30 is in an expanded configuration E″ which is relatively more expanded than the expanded configuration E of FIG. 6 for like sized support structures 12. Advantageously, the stops 32 displace a portion of the mousepad in this configuration in a region 70 which corresponds to where a user may conveniently rest his or her forearm or wrist when operating mouse of like device. The mousepad 10 thus provides a versatile and ergonomic device for enhancing user comfort when operating a mouse or other device.

FIG. 8 illustrates a mousepad 10′ according to another embodiment having a base portion 20′ and a clamp portion 30′ formed together, wherein the clamp portion 30′ is shown in an unexpanded configuration U′. The clamp portion 30′ includes a unitary resilient member 50′ having a profile that gradually curves from the base portion 20′ to provide a gradual transition to a rounded nose or tip 38′. The clamp portion 30′ defines a cavity 37′ having a generally elliptical shape and includes a stop 32′ having a front surface 33′ for abutting a support structure 12 when the mousepad 10′ is positioned for use. The clamp portion 30′ includes legs 34′ and feet 36′ which are configured to elastically deform away from the unexpanded configuration U′ to receive the support structure 12. The unitary resilient member 50′ is bonded, joined or otherwise connected to a base material 46′ of the mousepad 10′ which defines the base portion 20′ and at least a part of the clamp portion 30′. An upper surface of the base material 46′ and hence mousepad 10′ may include a fabric skin (not shown), such as, for example, a Lycra™ fiber skin or woven polyester fiber skin to increased wear resistance of the mousepad or enhance operational performance. In other embodiments, the upper surface may include a thin layer of other materials, including, for example, a thin plastic layer, and the upper layer may include various graphics, which may be customized. In still other embodiments, the upper surface may include a textured finish. In use, a lower surface 54′ of the mousepad 10′ is supported on a support structure 12 while the clamp portion 30′ grips or clamps onto an end or edge thereof. The present embodiment provides a particularly efficient form factor comprising a small number of separately distinguishable materials.

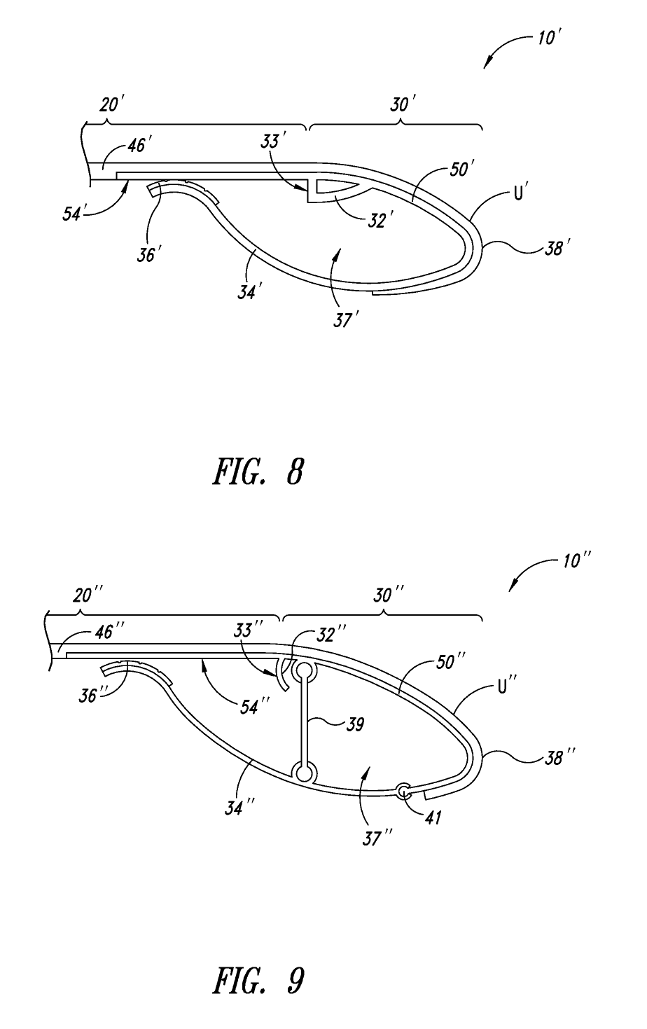

FIG. 9 illustrates a mousepad 10″ similar to the aforementioned embodiment having a base portion 20″ and a clamp portion 30″ formed together, wherein the clamp portion 30″ is shown in an unexpanded configuration U″. The clamp portion 30″ includes a rigid or semi-rigid member 50″ having a profile that gradually curves from the base portion 20″ to provide a gradual transition to a rounded nose or tip 38″. The rigid or semi-rigid member 50″ is hingedly coupled to rigid or semi-rigid legs 34″ about hinge 41 to pivot toward an expanded configuration (not shown). The clamp portion 30″ further includes a biasing member 39 coupled between the legs 34″ and opposing structure of the mousepad 10″ to provide biasing of the legs 34″ towards the unexpanded configuration U″. For example, in some embodiments, the biasing member 39 may be an elastomeric band which biases the legs 34″ toward the unexpanded configuration U″ when the legs 34″ are displaced to the expanded configuration. Similar to the aforementioned embodiment, the clamp portion 30″ defines a cavity 37″ having a generally elliptical shape and includes a stop 32″ having a front surface 33″ for abutting a support structure 12 when the mousepad 10″ is positioned for use. The clamp portion 30″ includes legs 34″ and feet 36″ which are configured to move away from the unexpanded configuration U″ to receive the support structure 12. The rigid or semi-rigid member 50″ is bonded, joined or otherwise connected to a base material 46″ of the mousepad 10″ which defines the base portion 20″ and at least a part of the clamp portion 30″. An upper surface of the base material 46″ and hence mousepad 10″ may include a fabric skin (not shown), such as, for example, a Lycra™ fiber skin or woven polyester fiber skin, a plastic skin, or a skin of various other materials to increased wear resistance of the mousepad or enhance operational performance. In use, a lower surface 54″ of the mousepad 10″ is supported on a support structure 12 while the clamp portion 30″ grips or clamps onto an end or edge thereof.

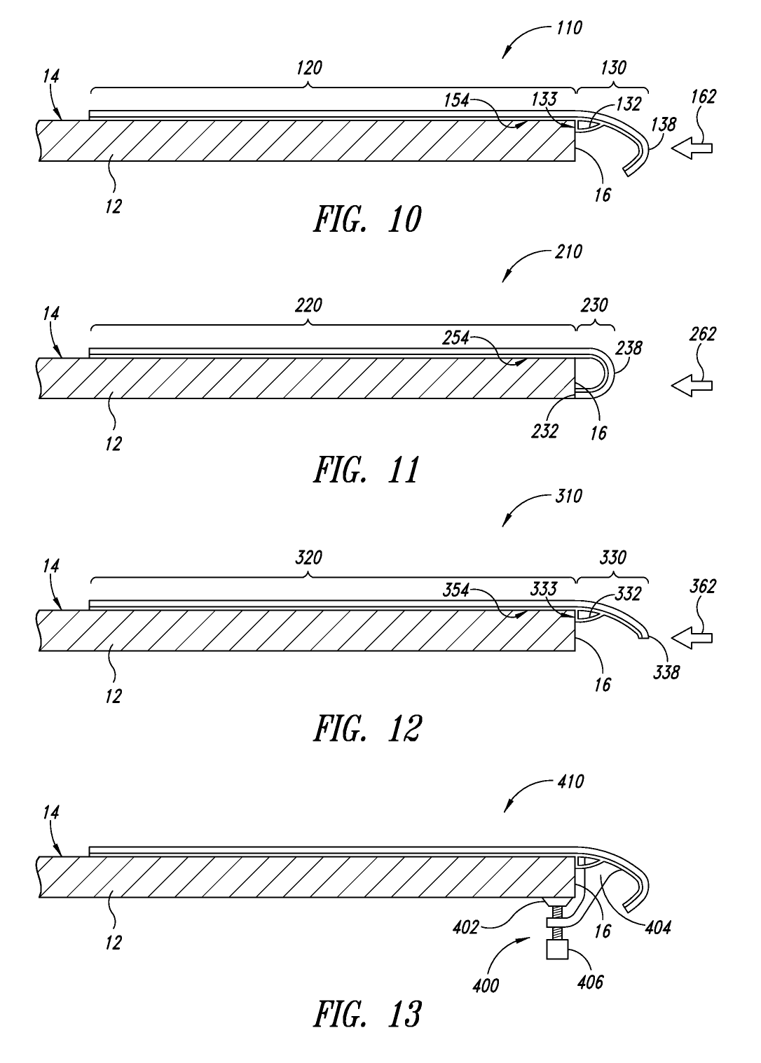

FIG. 10 illustrates a mousepad 110 according to another embodiment in which the mousepad 110 has a base portion 120 and a nose portion 130 formed together, wherein the nose portion 130 is configured to be cantilevered from a support structure 12 when the mousepad 110 is positioned for use. The nose portion 130 includes a stop 132 having a front surface 133 to abut an edge 16 of the support structure 12 when a lower surface 154 of the mousepad 110 is positioned on an upper surface 14 of the support structure 12 and the mousepad 110 is urged in the direction indicated by the arrow labeled 162. In some embodiments, the lower surface 154 of the mousepad 110 may include micro suction cups, reusable adhesive layers or other gripping structures to enhance resistance to slippage between the mousepad 110 and the upper surface 14 of the support structure.

As shown in FIG. 10, the nose portion 130 has a profile that gradually curves from the base portion 120 to provide a gradual transition to a rounded nose or tip 138. The tip 138 may be offset from the surface 133 of the stop 132 at about one-half inch or more such that the tip 138 is positioned at least about one-half inch from the edge 16 of the support structure 12 during use. In some embodiments, the tip 138 may be positioned at least one inch, two inches or more from the edge 16 of the support structure 12 during use. In the illustrated embodiment of FIG. 10, the cantilevered nose portion 130 traces a profile which changes in direction more than ninety degrees from a direction defined by the base portion 120 of the mousepad 110 when positioned for use. In other embodiments, the nose portion 130 may trace a profile which changes in direction less than ninety degrees. In other embodiments, the nose portion 130 may trace a profile which changes in direction at least about thirty-five degrees from a direction defined by the base portion of the mousepad when positioned for use, and in still other embodiments, at least about fifty-five degrees. In still further embodiments, the nose portion 130 may trace a profile that changes in direction at least about seventy-five degrees from a direction defined by the base portion of the mousepad when positioned for use.

FIG. 11 illustrates a mousepad 210 according to yet another embodiment in which the mousepad 210 has a base portion 220 and a nose portion 230 formed together, wherein the nose portion 230 is configured to be cantilevered from a support structure 12 when the mousepad 210 is positioned for use. The nose portion 230 in this embodiment defines a stop 232 at a terminal end of the mousepad 210 to abut an edge 16 of the support structure 12 when a lower surface 254 of the mousepad 210 is positioned on an upper surface 14 of the support structure 12 and the mousepad 210 is urged in the direction indicated by the arrow labeled 262. The nose portion 230 has a profile that gradually curves from the base portion 220 to provide a gradual transition to a rounded nose or tip 238. In the illustrated embodiment of FIG. 11, the nose portion 230 traces a profile which changes in direction about 180 degrees from a direction defined by the base portion 220 of the mousepad 210 when positioned for use.

FIG. 12 illustrates a mousepad 310 according to yet another embodiment in which the mousepad 310 has a base portion 320 and a nose portion 330 formed together, wherein the nose portion 330 is configured to be cantilevered from a support structure 12 when the mousepad 310 is positioned for use. The nose portion 330 in this embodiment includes a stop 332 having a front surface 333 to abut an edge 16 of the support structure 12 when a lower surface 354 of the mousepad 310 is positioned on an upper surface 14 of the support structure 12 and the mousepad 310 is urged in the direction indicated by the arrow labeled 362. The nose portion 330 has a profile that gradually curves from the base portion 320 to provide a gradual transition to a rounded nose or tip 338. In the illustrated embodiment of FIG. 12, the nose portion 330 traces a profile which changes in direction about ninety degrees from a direction defined by the base portion 320 of the mousepad 310 when positioned for use.

FIG. 13 illustrates a mousepad 410 according to still yet another embodiment in which the mousepad 410 has a structure similar to the mousepad illustrated in FIG. 10 but which further includes a clamp 400 integrally formed therewith. The clamp 400 includes an arm 404 extending from an underside of the mousepad 410 which supports a clamp member 402 for selectively gripping or clamping to the support structure 12. A knob, handle or dial 406 may be provided to selectively bias the clamp member 402 into tighter engagement with the support structure 12 by turning or rotating the same. In the illustrated embodiment of FIG. 13, the clamp 400 and surrounding structure of the mousepad 410 resembles a C-clamp structure. It is appreciated, however, that the clamp 400 may take a variety of different forms and shapes and may resemble other conventional clamping devices or fasteners, such as, for example, an over center toggle clamp.

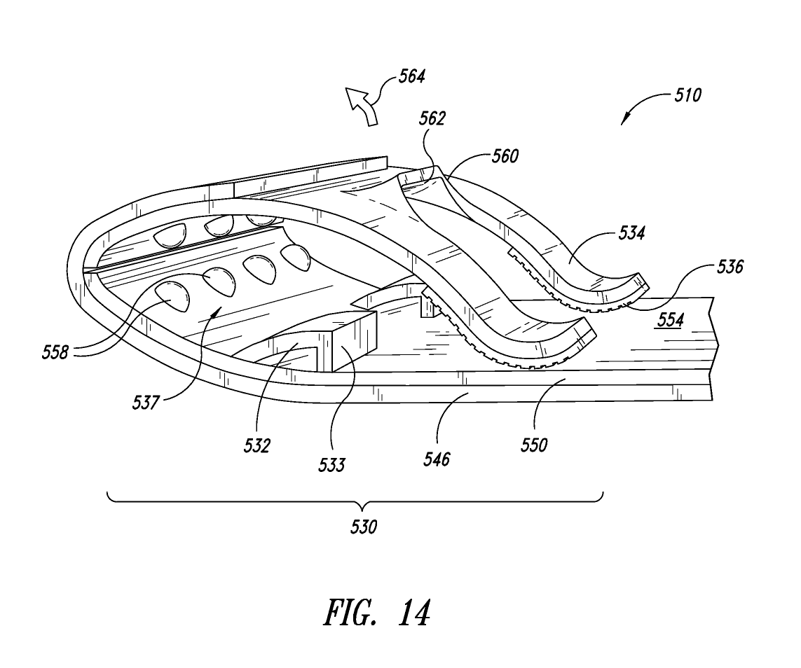

FIG. 14 illustrates a mousepad 510 according to still yet another embodiment having a structure similar to the mousepad illustrated in FIGS. 1 through 7. For example, the mousepad 510 includes a clamp portion 530 having a lower layer 550 preferably made of a semi-rigid, resilient material such that the clamp portion 530 of the mousepad 510 can flex elastically between the unexpanded configuration shown in FIG. 14 and an expanded configuration to clamp onto a desk or other support structure. The lower layer 550 may be adhered to or otherwise joined to an upper layer 546 made of a different material, such as, for example neoprene. The clamp portion 530 may further include legs 534 that are configured to flex away from a neutral or unexpanded configuration, as shown in FIG. 14, toward an expanded configuration. The legs 534 may include feet 536 to aid in gripping the underside of a desk or other support structure when a lower surface 554 of the mousepad is positioned thereon. For instance, the feet 536 may be ribbed structures made of natural or synthetic rubber or other materials for increasing frictional resistance between the clamp portion 530 and a desk or support structure received therein.

The clamp portion 530 of the mousepad 510 may define an elongated cavity 537. The mousepad 510 may include stops 532 for abutting a front edge of a desk or other support structure to which the mousepad 510 may be attached. The stops 532 may be positioned within the elongated cavity 537 defined by the clamp portion 530. In addition, the stops 532 may be formed integrally with one or more layers of the mousepad 510. When provided, the stops 532 may include a front surface 533 that is perpendicular or nearly perpendicular to an adjoining surface the mousepad 510. Supplemental stops 558 in the form of protuberances, for example, may also be provided for abutting an edge or other portion of a desk or other support structure when the mousepad 510 is positioned such that the primary stops 532 are received on an upper support surface of the desk or other support structure. In some embodiments, the supplemental stops 558 may be hemispherical or other geometric shapes. The protuberances may conceal fasteners for securing the lower layer 550 of the clamp portion 530 to an internal spring member (not shown). In other instances, the protuberances may be omitted.

The clamp portion 530 of the mousepad 510 may further include a gripping feature 560 positioned between the legs 534 which includes a raised lip 562. The raised lip 562 may present a gradual curvature leading toward the elongated cavity 537 to be gripped by the user to manually displace the legs 534 of the clamp portion 530 away from the unexpanded configuration as indicated by the arrow labeled 564. Accordingly, a use may position the mousepad 510 near the edge of a desk using one hand, leverage a portion of the mousepad 510 against the desk, displace the legs 534 with the same one hand using the gripping feature 560, and then slide the mousepad 510 toward the edge of the desk until the stops 532 abut the edge of the desk. Consequently, a user may conveniently install the mousepad 510 on a desk or other structure with one hand, if desired, in a particularly efficient and user-friendly manner. The gripping feature 560 may be formed in a variety of shapes and sizes to facilitate gripping of the clamp portion 530 and transitioning the clamp portion 530 toward an expanded configuration. The gripping portion 560 may also be integral to the clamp portion 530 or may be a separate component attached to the clamp portion 530 with fasteners or other attachment mechanisms.

Although the mousepads 10, 10′, 10″, 110, 210, 310, 410, 510, 610, 710 of the illustrated embodiments are shown in many of the figures as attaching to a generally planar support structure 12 having a flat leading edge 16, it is appreciated that the mousepads described herein may attach to a wide range of support structures including those having curvilinear and irregularly shaped edges. For example, the mousepads may attach to tables, desks, counters, and other structures having beveled edges or bullnose edges. In addition, although the base portion of the mousepads are illustrated as generally flat, rectangular pads, it is appreciated that the mousepads may be other shapes and may include raised portions for other ergonomic purposes, such as, for example, an integral wrist support pad protruding from an upper surface of the mousepad.

Moreover, the various embodiments described and shown herein can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mousepad for a mouse device, the mousepad comprising:
a base portion having an upper surface upon which the mouse device can operate; and
a clamp portion to selectively attach the mousepad to a support structure, the clamp portion movable between an unexpanded configuration and an expanded configuration, opposing sections of the clamp portion moving away from each other when the clamp portion moves from the unexpanded configuration toward the expanded configuration to receive the support structure.

2. The mousepad of claim 1, further comprising:
at least one stop on an underside of the mousepad, the stop positioned to abut the support structure when the mousepad is attached thereto.

3. The mousepad of claim 2 wherein the at least one stop is integrally formed in a layer of the mousepad.

4. The mousepad of claim 2 wherein the clamp portion defines an elongated cavity when the clamp portion is in the unexpanded configuration, and wherein the at least one stop is positioned within the elongated cavity.

5. The mousepad of claim 1 wherein a profile of the clamp portion includes a gradual curvature from an area near an interface of the base portion and the clamp portion toward a nose of the mousepad, the gradual curvature masking any sharp edge at the end of the support structure when the mousepad is attached to the support structure.

6. The mousepad of claim 5 wherein a profile of the clamp portion includes a general c-shape, a height of the c-shape varying as the clamp portion moves between the unexpanded configuration and the expanded configuration.

7. The mousepad of claim 6 wherein the clamp portion includes a generally c-shaped spring element.

8. The mousepad of claim 6 wherein a relief gap is provided in the clamp portion near the nose of the mousepad.

9. The mousepad of claim 1 wherein the base portion is a multi-layered structure including at least a first layer and a second layer.

10. The mousepad of claim 9 wherein the first layer and the second layer are neoprene materials having different porosities.

11. The mousepad of claim 9 wherein the multi-layered structure further includes an upper fabric layer.

12. The mousepad of claim 9 wherein the second layer of the base portion seamlessly extends at least to a nose of the mousepad such that the second layer defines at least a part of the clamp portion.

13. The mousepad of claim 12 wherein the second layer of the base structure seamlessly extends past the nose such that the second layer has a general j-shape when the mousepad is attached to the support structure.

14. The mousepad of claim 1 wherein the clamp portion is selectively expandable to receive generally planar support structures of varying thicknesses.

15. The mousepad of claim 1 wherein the clamp portion includes a pair of legs and a raised lip positioned between the pair of legs to enable a user to displace the pair of legs of the clamp portion away from the unexpanded configuration.

16. A mousepad comprising:
a sheet structure having an upper surface upon which a mouse device can operate; and
a resilient, generally c-shaped clamp coupled to the sheet structure, the clamp expandable from an initial configuration to an expanded configuration for selectively attaching the mousepad to a generally planar support structure.

17. The mousepad of claim 16 wherein the mousepad is configured to mask a corner of the support structure with a portion of the mousepad having a gradual curvature when the mousepad is attached to the support structure.

18. A mousepad for a mouse device, the mousepad comprising:
a base portion having an upper surface upon which the mouse device can operate; and
a nose portion formed together with the base portion, the nose portion configured to be cantilevered from a support structure when the mousepad is positioned for use and the nose portion including a profile with a gradual curvature which traces a profile that changes in direction at least about thirty-five degrees from a direction defined by the base portion of the mousepad when positioned for use.

19. The mousepad of claim 18, further comprising:
a clamp integrally formed with the nose portion, the clamp configured to selectively engage the support surface when the mousepad is positioned for use.

20. The mousepad of claim 18, further comprising:
a stop integrally formed with the nose portion, the stop positioned to abut an edge of the support structure when the mousepad is positioned for use.

21. The mousepad of claim 20 wherein the nose portion defines a rounded tip, the rounded tip positioned at least one-half inch from the edge of the support structure when the mousepad is positioned for use and the stop abuts the edge.

22. A method for attaching a mousepad to a support structure, the method comprising:
moving an end of a clamp portion of the mousepad away from a lower surface of the mousepad; and
positioning the mousepad such that the support structure is received by the clamp portion and a base portion of the mousepad lies on an upper support surface of the support structure.

23. The method of claim 22 wherein positioning the mousepad includes moving the mousepad towards the support structure until a stop of the mousepad abuts the support structure.

24. The method of claim 22 wherein positioning the mousepad includes positioning the mousepad such that a stop of the mousepad rests on the upper support surface of the support structure, the stop thereby positioning a portion of the mousepad away from the upper support surface.

25. The method of claim 24 wherein positioning the mousepad further includes positioning the mousepad such that the clamp portion abuts an end of the support structure.

26. The method of claim 22 wherein moving the end of the clamp portion of the mousepad away from the lower surface of the mousepad includes moving a pair of legs of the clamp portion away from the lower surface via a raised lip positioned between the pair of legs.
